(19) United States
(12) Patent Application Publication
(10) Pub. No.: US 2014/0082559 A1
(43) Pub. Date: Mar. 20, 2014

(54) CONTROL AREA FOR FACILITATING USER INPUT

(71) Applicant: Bradley Neal Suggs, Sunnyvale, CA (US)

(72) Inventor: Bradley Neal Suggs, Sunnyvale, CA (US)

(21) Appl. No.: 13/982,710

(22) PCT Filed: Feb. 22, 2011
(86) PCT No.: PCT/US11/25722

§ 371 Date: Jul. 30, 2013

(51) Int. Cl. G06F 3/0482; G06F 3/0481

(52) U.S. Cl. CPC G06F 3/0482; G06F 3/04817
USPC 715/835

(57) ABSTRACT

Embodiments of the present invention disclose a magnified control area for facilitating user input. According to one embodiment, a gesture input from a user operating the computing system is detected and an on-screen location of the gesture input is determined. Furthermore, a positional indicator corresponding to the determined on-screen location of the gesture input is displayed to the user, while a control area is presented around the positional indicator. Moreover, movement of the positional indicator along a boundary of the control area causes the control area to move correspondingly so as to keep the positional indicator within the boundary of the control area.

### BACKGROUND

Providing efficient and intuitive interaction between a computer system and users thereof is essential for delivering an engaging and enjoyable user-experience. Today, most computer systems include a keyboard for allowing a user to manually input information into the computer system, and a mouse for selecting or highlighting items shown on an associated display unit. As computer systems have grown in popularity, however, alternate input and interaction systems have been developed.

For example, touch-sensitive, or touchscreen computer systems allow a user to physically touch the display unit and have that touch registered as an input at the particular touch location, thereby enabling a user to interact physically with objects shown on the display. In addition, hover-sensitive computing systems are configured to allow input from a user's fingers or other body part when positioned in close proximity to—but not physically touching—the display surface. Often times, however, a users input or selection may be incorrectly or inaccurately registered by present computing systems.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIGS. 1A and 1B are three-dimensional perspective views of an operating environment utilizing the magnified control area for facilitating user input according to an example of the present invention.

FIG. 2 is a simplified block diagram of the system implementing the magnified control area for facilitating user input according to an example of the present invention.

FIGS. 3A-3C are various screen shots of the magnified control area and sample user interlace according to an example of the present invention.

FIG. 4 is a simplified flow chart of the processing steps for providing the magnified control area in accordance with an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

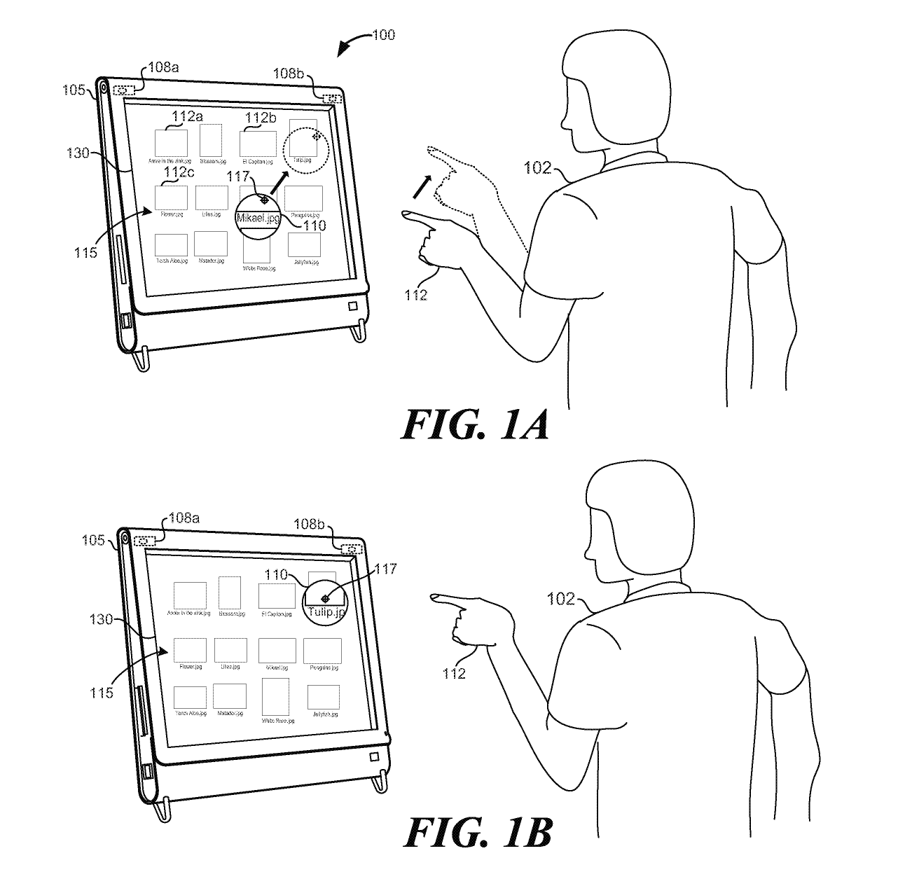

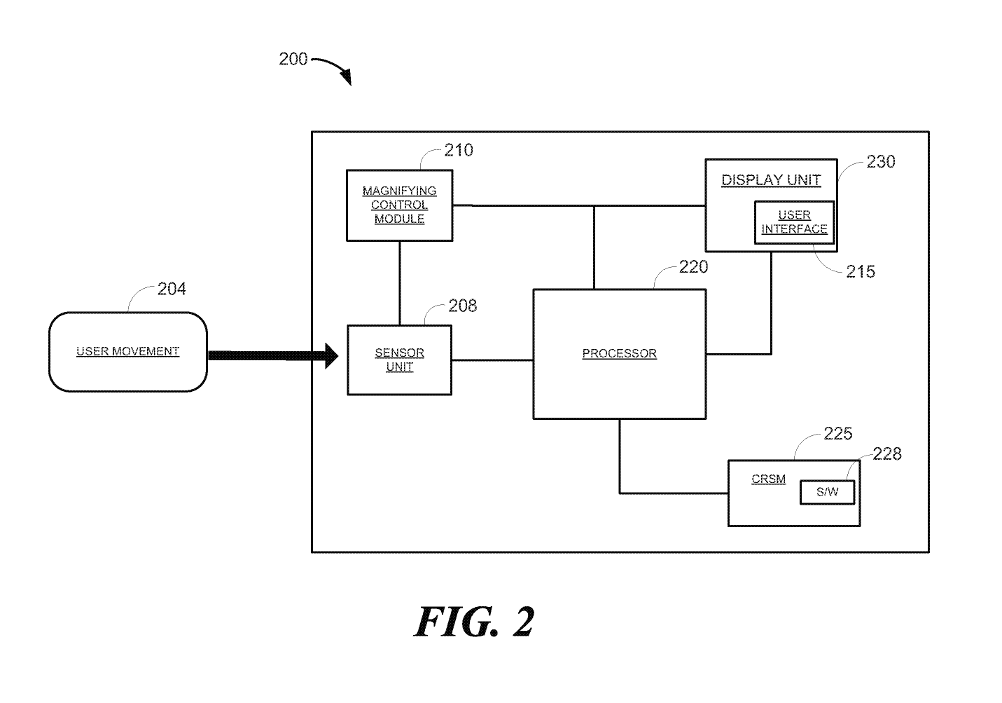

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

One solution to the aforementioned problem aimed at touch input, is the “touch pointer”, a software utility that may be enabled on certain touch-enabled systems. In this approach, a graphical tool (e.g., mouse icon) is used in order to allow users to target small objects on the display that may be difficult to select with larger fingers. This solution, however, requires the same activation behavior as a mouse with buttons, namely left mouse click, right mouse click, drag, etc, and thus requires additional triggering events.

Examples of the present invention provide a magnified control area for facilitating user input. More particularly, the system of the present examples takes positional input and translates motions over displayed elements into executed commands using a magnified control area and positional indicator. Accordingly, command execution may be provided for the user without a substantial change of command location. Accordingly, operation commands may be executed at some location without the need for a separate triggering mechanism.

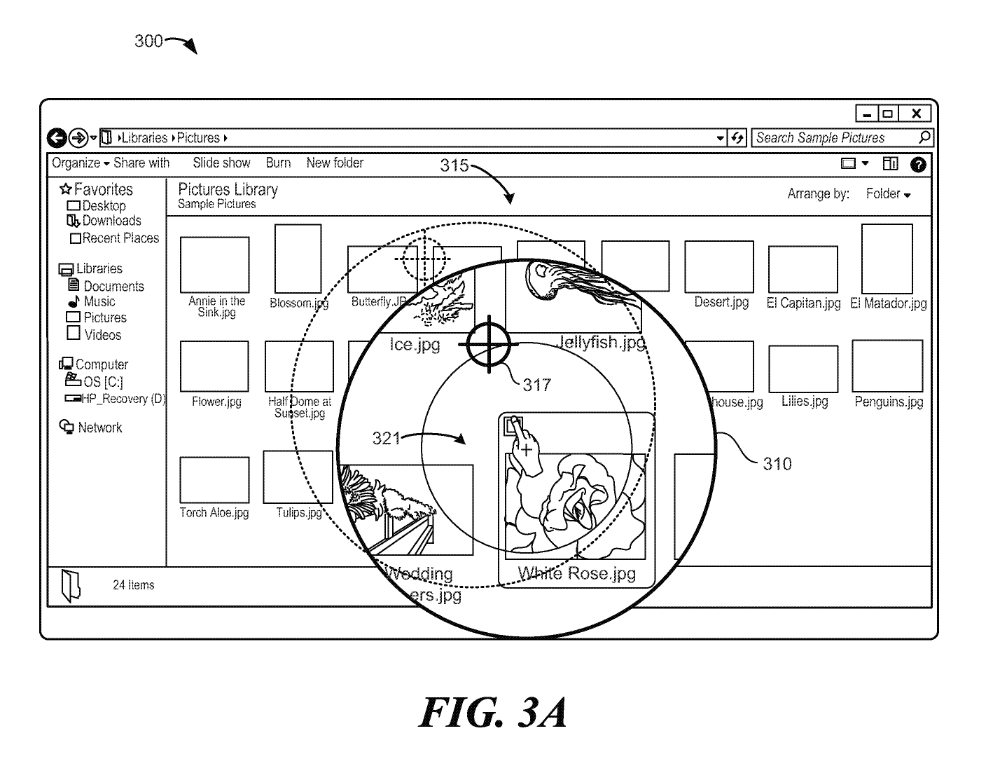

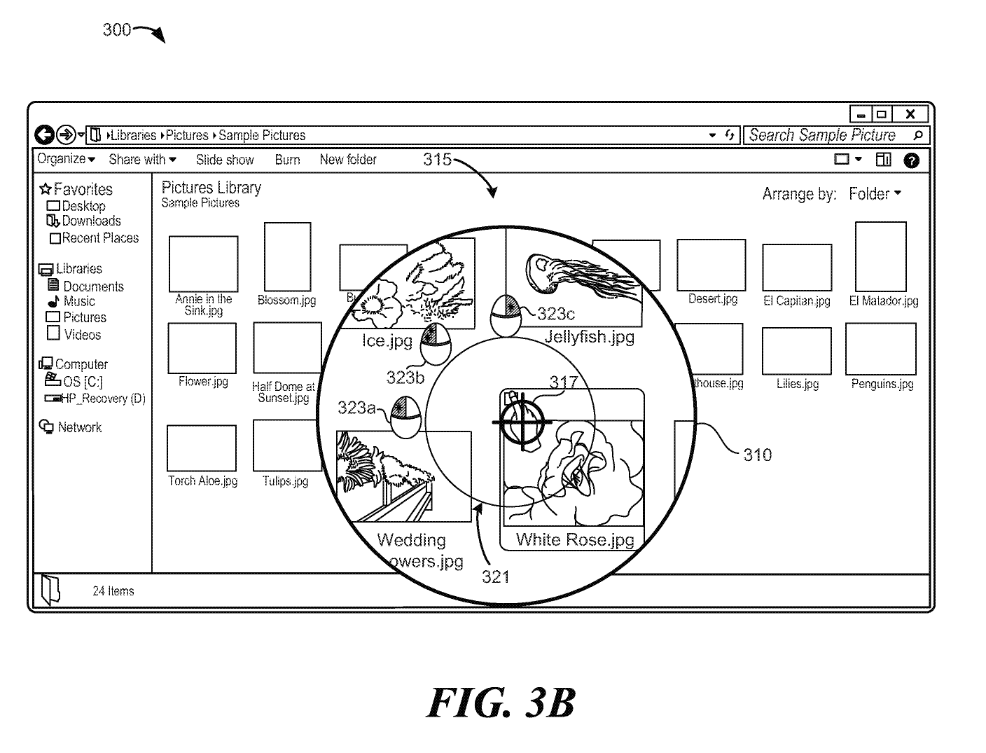

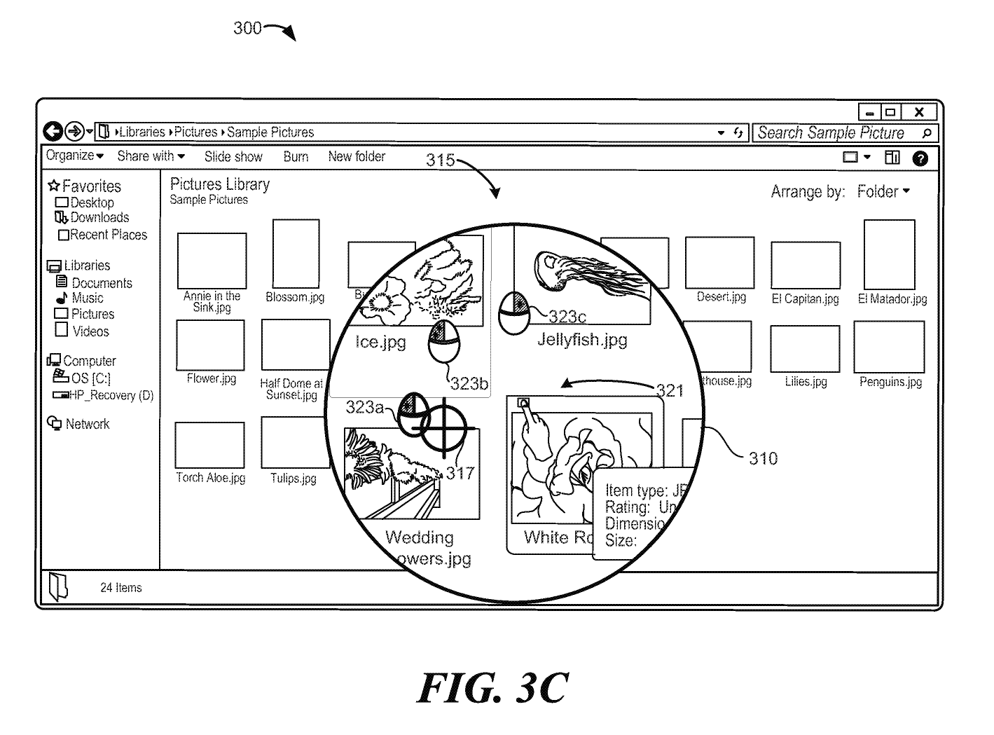

Referring now in more detail to the drawings in which like numerals identify corresponding parts throughout the views, FIGS. 1A and 1B are three-dimensional perspective views of an operating environment utilizing the magnified control area for facilitating user input according to an example of the present invention. FIG. 1A depicts a user 102 operating a depth-sensing computing system 100. In the present example, the computing system 100 includes a casing 105 having a display unit 130 and a pair of three-dimensional optical sensors 108a and 108b housed therein. As shown in FIG. 1A, a user interface 115 running on the computing system displays a plurality of objects 112a-112c for selection by the user 102. Here, the user 102 positions his finger in the direction of the one of the selectable objects of the user interface 115. As a result, the system determines a target or on-screen location of the user input, which is represented by a positional indicator 117. In addition to displaying the positional indicator 117, the system displays a magnified control area 110 around the positional indicator 117. According to one example, the magnified control area 110 magnifies an associated area of the display and user interface as will be described in more detail with reference to FIGS. 3A-30. However, the magnified control area may be configured to have a magnification level of one for example, in which case the corresponding area of the user interface is not magnified by the magnifying control area 110. Furthermore, when the user moves the gesturing body part (e.g., finger or hand) along a boundary of the magnified control area as indicated by the directional arrow of FIG. 1A, both the positional indicator 117 and the magnified control area 110 are repositioned to correspond to the user's movement. According to one example, movement of the magnified control area ceases once the positional indicator is repositioned within a central region of the magnified control area. This operation is shown in FIG. 1B in which the positional indicator 117 and the magnified control area 110 have been relocated—based on the user's movement in FIG. 1A—from a central region of the display unit 130 to a top-right region of the display unit 130. Accordingly, the magnified control area 110 now magnifies the associated top-right region of the user interface 115 and display unit 130 as shown in FIG. 1B.

FIG. 2 is a simplified block diagram of the system implementing the magnified control area for facilitating user input according to an example of the present invention. As shown in this exemplary embodiment, the system 200 includes a processor 220 coupled to a display unit 230, a magnifying control module 210, a computer-readable storage medium 225, sensor unit 208. In one embodiment, processor 220 represents a central processing unit configured to execute program instructions. Display unit 230 represents an electronic visual display such as touch-sensitive or hover-sensitive flat panel monitor configured to display images and a graphical user interface 215 for enabling interaction between the user and the computer system.

Sensor unit 208 represents a depth-sensing device such as a three-dimensional optical sensor configured to capture measurement data related to an object (e.g., user body part) in front of the display unit 230. The magnifying control module 210 may represent an application program or user interface control module configured to receive and process measurement data of a detected object from the sensing device 208, in addition to magnifying particular areas and objects of the user interface 215. Storage medium 225 represents volatile storage (e.g. random access memory), non-volatile store (e.g. hard disk drive, read-only memory, compact disc read only memory, flash storage, etc.), or combinations thereof. Furthermore, storage medium 225 includes software 228 that is executable by processor 220 and, that when executed, causes the processor 220 to perform some or all of the functionality described herein. For example, the magnifying control module may 210 may be implemented as executable software within the storage medium 225.

FIGS. 3A-3C are various screen shots of the magnified control area and a sample user interface according to an example of the present invention. As shown in the example of FIG. 3A, a magnified control area 310 overlays an area of the user interface 315. Several interactive objects 312a-312c are also displayed on the user interface for selection by an operating user. Once the user seeks to interact with the system by making a gesture input, the system determines an approximate on-screen location of the input and displays a positional indicator 317 at the determined location. The magnified control area 310 is displayed around the positional indicator 317, while also magnifying objects or graphics within its boundary or periphery 323 as shown in FIG. 3A. Moreover, movement of the positional indicator—in response to movement of the user's body part—along the outer boundary 323 of the magnified control area 310 also causes the magnified control area to move in the same direction so as to keep the positional indicator 317 within the magnified control area 310. For example, movement of the positional indicator 317 in the northwest direction would cause a “drag” effect in which the magnified control area 310 would move correspondingly as indicated by the dotted lines shown in FIG. 3A. However, when the positional indicator is moved within the magnified control area, but not along a boundary thereof, the magnified control area may remain stationary.

Referring now to the depiction of FIG. 3B, the positional indicator 317 is positioned within the central region 321 of the magnified control area 310. In response, the system of the present examples locks the magnified control area 310 in place and populates operation command icons 323a-323c within the magnified control area 310. As shown here, these command icons 323a-323c are displayed just outside the designated central region 321 of the magnified control area 310. Each operation command icon 323a-323c is associated with a different operational command to be executed on the computing system. In the present example, command icon 323a represents a left mouse click operation; command icon 323b represents a double left mouse click operation, while command icon 323c represents a right mouse click operation. However, examples of the present invention are not limited to these mouse-related operations and may include any type of control operation capable of execution by the processor.

As shown in the example of FIG. 3C, the user places the positional indicator 317 over the operation command icon 323a. The system recognizes this action as selection of the representative operational command (e.g., left mouse click) and locks the selected command icon. According to one example of the present invention, execution of the selected command operation occurs once the user moves the positional indicator back to the central region 321 of the magnified control area 310, thereby confirming the user's desire for command execution. In an alternate example, however, execution of an operational command may occur immediately upon selection of an associated operation command icon.

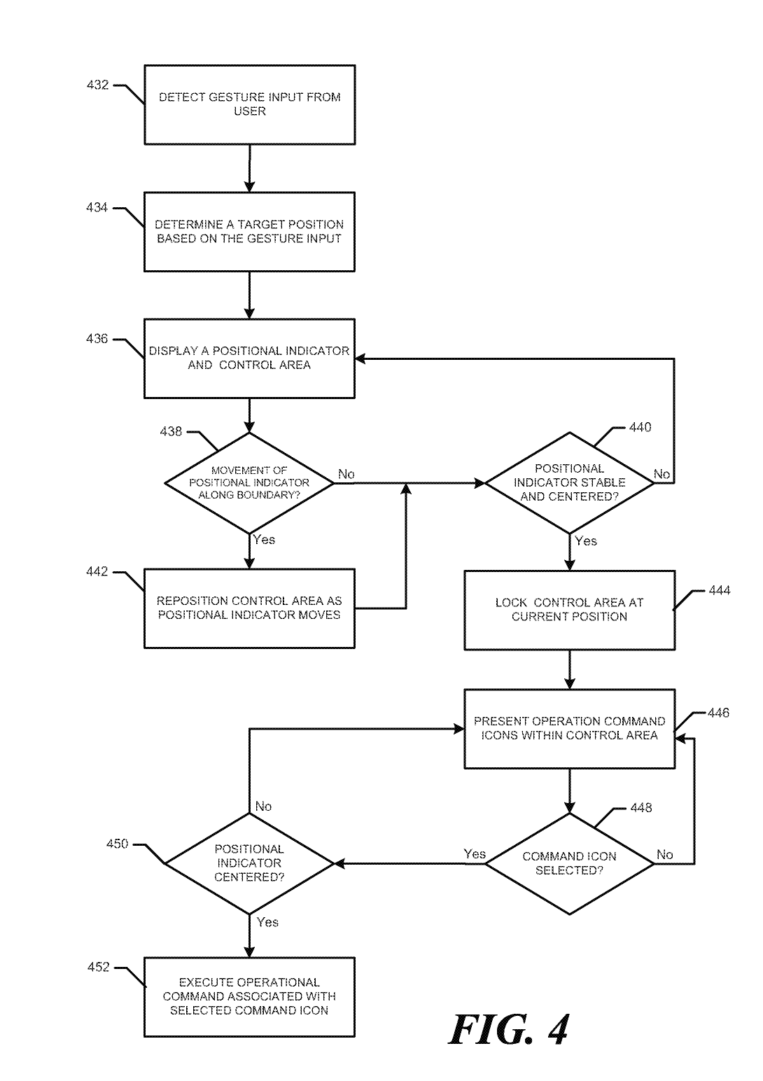

FIG. 4 is a simplified flow chart of the processing steps for providing the magnified control area in accordance with an example of the present invention. In step 432, the system detects a gesture, or movement of a user's body part (e.g. finger or hand) in front of the display. Next, in step 434, an on-screen location or target position is determined based on the detected gesture. In response, a positional indicator and magnified control area are displayed on the user interface in step 436. As described above, the magnified control area may be a circular magnifying area that surrounds the positional indicator, which may be initially centered within the magnified control area in accordance with one example. Still further, the magnified control area may initially remain stationary while the positional indicator is free to move in response to the changing location of the user's gesture or body movement. If, in step 438, the user moves the positional indicator along a boundary of the magnified control area via a corresponding gesture or movement, then the magnified control area is also moved so as to keep the positional indicator within the magnified area in step 442.

On the other hand, if the system determines that the positional indicator is positioned and stable within the central region of the magnified control area in step 440, then the magnified control area becomes locked and fixed at its current position in step 444. Simultaneously, in step 446, the system displays at least one operation command icon within the magnified control area for selection by the operating user as described in detail above. According to one example of the present invention, execution of a selected operational command (step 452) occurs when 1) the positional indicator is moved over the corresponding operation command icon so as to lock the operational command to be executed (step 448), and 2) the positional indicator re-enters the central region of the magnified control area thus confirming the user's selection of the particular operational command (step 450).

Many advantages are afforded by the magnified control area in accordance with examples of the present invention. For example, depth sensing technologies may use fluid motions to accomplish tasks rather than static trigger poses as utilized in conventional touch and hover systems. Furthermore, gesture interaction and the magnified control area may be provided for current depth-sensing optical systems without requiring the installation of additional hardware. Still further, the magnified control area helps to accomplish precise positioning while accommodating for imprecise input from the user, thereby ensuring that only appropriate and useful operations are selected by the user. Moreover, examples of the present invention are particularly useful in systems where identification of a gesture to trigger an action is linked to the motion of the point at which the command might be executed.

Furthermore, while the invention has been described with respect to exemplary embodiments, one skilled in the art will recognize that numerous modifications are possible. For example, although exemplary embodiments depict an all-in-one desktop computer as the representative computing device, the invention is not limited thereto. For example, the computing device may be a notebook personal computer, a netbook, a tablet personal computer, a cell phone, or any other electronic device configured for touch or hover input detection.

Furthermore, the magnified control area may comprise of any shape or size and may be manually configured by the operating user. Similarly, the magnification level may vary in intensity, while the graphical command icons may vary in number (Le., one or more) and appearance. Thus, although the invention has been described with respect to exemplary embodiments, it will be appreciated that the invention is intended to cover all modifications and equivalents within the scope of the following claims.

What is claimed is:

1. A method for facilitating user interaction with a computing system having a display unit and graphical user interface, the method comprising:
detecting a gesture input of a user operating the computing system;
determining an on-screen location of the gesture input;
displaying, on the graphical user interface, a positional indicator that corresponds to the on-screen location of the gesture input; and
presenting a control area around the positional indicator of the gesture input,
wherein movement of the positional indicator via gesture input from the user along a boundary of the control area causes the control area to move correspondingly so as to keep the positional indicator within the boundary of the ii control area.

2. The method of claim I, further comprising:
displaying at least one operation command icon within the control area for selection by the user.

3. The method of claim 2, further comprising:
magnifying an area of the user interface that corresponds to a location of the control area.

4. The method of claim 3, further comprising:
locking the location of the control area when the positional indicator is positioned within a central region of the control area by the user.

5. The method of claim 4, further comprising:
receiving selection of a operation command icon from the user; and
executing an operational command related to the selected command icon on the computing system.

6. The method of claim 4, wherein the at least one operation command icon is displayed when the control area is locked in position by the user.

7. The method of claim 6, wherein a plurality of operation command icons are displayed within the control area.

8. A computer readable storage medium for facilitating user input, the computer readable storage medium having stored executable instructions, that when executed by a processor, causes the processor to:
determine a target location of a gesture input received from a user, wherein the target location relates to an on-screen location of a display;
display a positional indicator that corresponds to the target location of the gesture input;
display a magnified control area around the positional indicator, wherein the magnified control area magnifies an associated area of the display;
populate at least one operation command icon within the magnified control area for selection by the user; and
reposition the magnified control area as the positional indicator and corresponding gesture input are moved along an edge of the magnified control area so that positional indicator remains within the magnified control area.

9. The computer readable storage medium of claim 8, wherein the executable instructions further cause the processor to:
populate at least one operation command icon within the magnified control area for selection by the user.

10. The computer readable storage medium of claim 10, wherein the executable instructions further cause the processor to:
lock the position of the magnified control area when the positional indicator is positioned in a central region of the magnified control area by the user.

11. The computer readable storage medium of claim 8, wherein the executable instructions further cause the processor to:
receive selection of a operation command icon from the user; and
execute an operational command associated with the selected command icon on the computing system.

12. A computing system for facilitating user input, the system comprising:
a display;
at least one sensor for detecting gesture movement from a user;
a user interface configured to display selectable elements on the display; and
a processor coupled to the at least one sensor and configured to:
determine an on-screen location to be associated with the gesture movement;
display a magnified control area that surrounds the determined on-screen location, wherein the magnified control area magnifies an associated area including the selectable elements of the user interface;
reposition the magnified control area as the positional indicator and corresponding gesture input moves along an edge of the magnified control area; and
display a plurality of operation command icons within the magnified control area for selection by the user.

13. The computing system of claim 12, wherein each operation command icon represents a different operational command to be executed on the computing system.

14. The computing system of claim 13, wherein each operation command icon represent various point and click operational commands associated with a computer mouse.

15. The computing system of claim 12, wherein the processor is further configured to:
display a positional indicator within the magnified control area that corresponds to the determined on-screen location of the gesture movement; and
lock the position of the magnified control area when the positional indicator is repositioned within a central region of the magnified control area by the user.
